(19) United States
(12) Patent Application Publication
(10) Pub. No.: US 2024/0219573 A1
(43) Pub. Date: Jul. 4, 2024

(54) THREE-DIMENSIONAL SPATIAL SCANNING SYSTEM AND METHOD

(71) Applicant: KOREA ELECTRONICS TECHNOLOGY INSTITUTE, Seongnam-si (KR)

(72) Inventors: Yunju LEE, Seoul (KR); Kyungtaek LEE, Seongnam-si (KR); Sukwoo JUNG, Seoul (KR)

(21) Appl. No.: 18/398,809

(22) Filed: Dec. 28, 2023

Related U.S. Application Data
(60) Provisional application No. 63/477,446, filed on Dec. 28, 2022.

(51) Int. Cl. G01S 17/894; G01S 7/4865; G01S 7/497; G01S 17/86

(52) U.S. Cl. CPC G01S 17/894; G01S 7/4866; G01S 7/497; G01S 17/86

(57) ABSTRACT

A 3D spatial scanning system and method can perform accurate 3D spatial scanning in various environments. The 3D spatial scanning system may include a sensor group, a confidence estimator, a function adjuster, and a fusion part. The sensor group may scan space using a time-of-flight (ToF) sensor and a stereo red-green-blue (RGB) sensor included therein. The confidence estimator may fuse a sensing value of the ToF sensor and a sensing value of the stereo RGB sensor and estimate a confidence of the sensing values. The function adjuster may adjust a function of at least one of the ToF sensor and the stereo RGB sensor based on the confidence estimated by the confidence estimator. The fusion part may fuse the sensing value of the ToF sensor and the sensing value of the stereo RGB sensor based on function adjustment of the function adjuster.

### CROSS REFERENCE TO RELATED APPLICATIONS

This application claims priority to U.S. Provisional Application No. 63/477,446 filed on Dec. 28, 20222, which is incorporated herein by reference in its entirety.

### BACKGROUND

### Technical Field

The present disclosure relates to three-dimensional (3D) spatial scanning technique. In particular, the present disclosure relates to 3D spatial scanning system and method that can improve the accuracy of 3D spatial scanning using a ToF sensor and a stereo RGB sensor.

### Description of Related Technology

Recently, technology for three-dimensionally scanning space by using a depth sensor that can recognize space has been actively researched.

### SUMMARY

One aspect is a 3D spatial scanning system and method capable of performing accurate 3D spatial scanning in various environments.

Another aspect is a three-dimensional (3D) spatial scanning system that includes a sensor group that scans space using a time-of-flight (ToF) sensor and a stereo red-green-blue (RGB) sensor included therein; a confidence estimator that fuses a sensing value of the ToF sensor and a sensing value of the stereo RGB sensor and estimates a confidence of the sensing values; a function adjuster that adjusts a function of at least one of the ToF sensor and the stereo RGB sensor based on the confidence estimated by the confidence estimator; and a fusion part that fuses the sensing value of the ToF sensor and the sensing value of the stereo RGB sensor based on function adjustment of the function adjuster.

The function adjusted by the function adjuster may include at least one of a sensing distance, a sensing resolution, a light reflection, and an illumination.

The 3D spatial scanning system may further include an object discriminator that determines whether an object is discriminated within a region of interest (ROI) of the sensor group, wherein the function adjuster may adjust the function again based on a discrimination result in the object discriminator.

Another aspect is a three-dimensional (3D) spatial scanning method that includes a sensing step in which space is scanned using a time-of-flight (ToF) sensor and a stereo red-green-blue (RGB) sensor; a confidence estimation in which a sensing value of the ToF sensor and a sensing value of the stereo RGB sensor are fused and a confidence of the sensing values is estimated; a function adjustment step in which a function of at least one of the ToF sensor and the stereo RGB sensor is adjusted based on the confidence estimated in the confidence estimation step; and a fusion step in which the sensing value of the ToF sensor and the sensing value of the stereo RGB sensor are fused based on function adjustment in the function adjustment step.

The 3D spatial scanning method may further include an object discrimination step of determining whether an object is discriminated within a region of interest (ROI) in the sensing step; and a function readjustment step in which the function of at least one of the ToF sensor and the stereo RGB sensor is readjusted based on a discrimination result in the object discrimination step.

The 3D spatial scanning system and method according to the present disclosure can improve the quality of 3D spatial scanning by fusing the sensing values of the ToF sensor and the stereo RGB sensor, estimating confidence, and then adjusting the sensor function according to the confidence.

### BRIEF DESCRIPTION OF THE DRAWINGS

FIG. 1 is a block diagram showing a 3D spatial scanning system according to an embodiment of the present disclosure.

FIGS. 2 to 4 are explanatory diagrams for a function adjustor of the 3D spatial scanning system according to an embodiment of the present disclosure.

FIG. 5 is a flowchart showing a 3D spatial scanning method according to an embodiment of the present disclosure.

### DETAILED DESCRIPTION

Scanning of a 3D space can be done using, for example, a fusion sensor of both a time-of-flight (ToF) sensor and a stereo red-green-blue (RGB) sensor.

The ToF sensor is a sensor that measures distance by measuring the time of flight of a laser. The ToF sensor does not suffer from performance degradation due to monochromatic surface objects, but it has poor resolution and is greatly affected by noise.

The stereo RGB sensor is a sensor that detects objects three-dimensionally using two lenses. The stereo RGB sensor can identify the perspective of an object as well as the shape of the object, but it has the problem of not being able to obtain distance information for objects with a monochromatic surface.

The fusion sensor of both the ToF sensor and the stereo RGB sensor can compensate for the shortcomings of each sensor.

However, the fusion sensor can only operate smoothly indoors within a measurement distance of about 5 meters, and have limitations in scanning large indoor or outdoor spaces. In other words, the accuracy of 3D space scanning is reduced in large indoor or outdoor spaces due to a distance to an object, a resolution, a light reflection, or a low illumination.

Now, embodiments of the present disclosure will be described in detail with reference to the accompanying drawings. However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

A 3D spatial scanning system according to the present disclosure is based on adopting a scheme of fusing the sensing values of a ToF sensor and a stereo RGB sensor. In other words, each sensor detects an object, and then the sensing values are fused. Therefore, even if one sensor fails to operate, the object can be continuously detected using another sensor. This is similar to the Late Fusion scheme.

A deep fusion sensor, which corresponds to the fusion of the ToF sensor capable of extracting depth information necessary for acquiring 3D spatial data and the stereo RGB sensor having high resolution and low noise, is selectively operated to improve the quality of data and the quality of 3D indoor/outdoor spatial scanning.

In addition, depending on the hardware performance of the ToF sensor and the stereo RGB sensor, the quality according to a sensing distance, a sensing resolution, the reflection and illumination of an external environment, etc. may vary. Therefore, a component capable of adjusting the sensor function based on confidence estimation is introduced.

The confidence estimation is made after objects are detected independently by each of the ToF sensor and the stereo RGB sensor and detection results are fused. Then, based on the result of the confidence estimation, the functions of the ToF-stereo fusion sensor (e.g., a sensing distance, a sensing resolution, the reflection and illumination of an external environment) are selected and adjusted.

Additionally, it is determined whether there is a recognized object within a region of interest, and the functions of the ToF-stereo fusion sensor are readjusted.

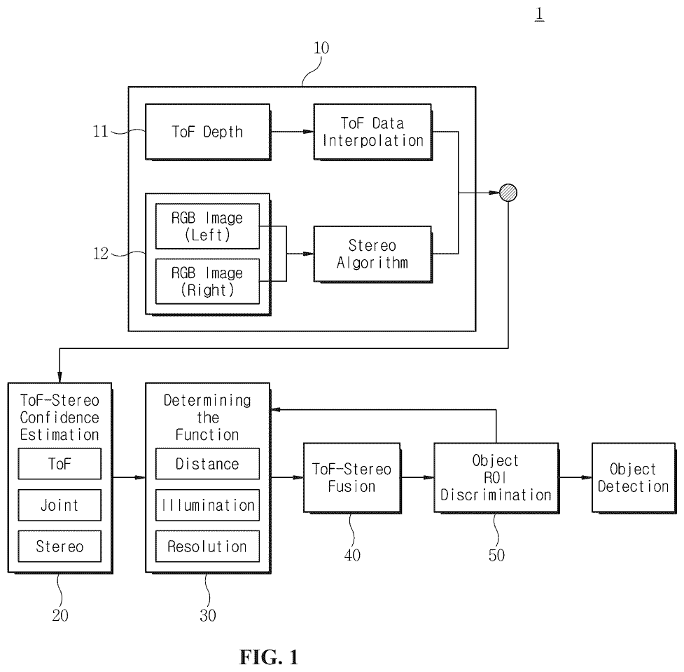

FIG. 1 is a block diagram showing a 3D spatial scanning system according to an embodiment of the present disclosure.

Referring to FIG. 1, the 3D spatial scanning system 1 according to an embodiment of the present disclosure includes a sensor group 10, a confidence estimator 20, a function adjuster 30, and a fusion part (or fusion processor) 40. In some embodiments, the 3D spatial scanning system 1 may further include an object discriminator 50.

The sensor group 10 scans space using a ToF sensor 11 and a stereo RGB sensor 12 included therein. The ToF sensor 11 is a sensor that measures distance by measuring the time of flight of a laser, and the stereo RGB sensor 12 is a sensor that detects objects three-dimensionally using two lenses. Each data from the ToF sensor 11 and the stereo RGB sensor 12 may be preprocessed before confidence estimation is performed in the confidence estimator 20.

The confidence estimator 20 fuses the sensing value of the ToF sensor 11 and the sensing value of the stereo RGB sensor 12 and estimates their confidence.

The function adjuster 30 adjusts the function of at least one of the ToF sensor 11 and the stereo RGB sensor 12 based on the confidence estimated by the confidence estimator 20.

The fusion part 40 fuses the sensing value of the ToF sensor 11 and the sensing value of the stereo RGB sensor 12 based on the function adjustment of the function adjuster 30.

The function adjusted by the function adjuster 30 may include at least one of a sensing distance, a sensing resolution, a light reflection, and an illumination.

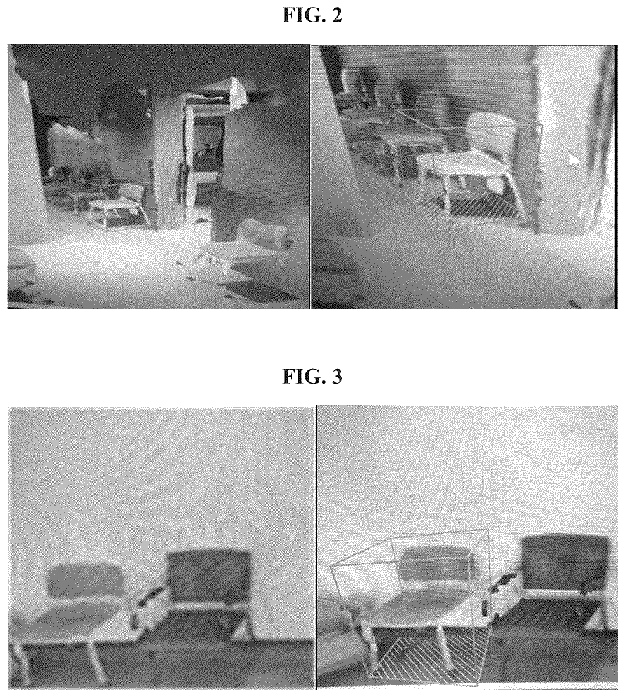

FIG. 2 is an explanatory diagram for the case where the function adjuster 30 adjusts a sensing distance function. In FIG. 2, the left photo is before adjusting the sensing distance function, and the right photo is after adjusting the sensing distance function.

In the case of low confidence, the function adjuster 30 can adjust the sensing distance function to reduce the distances to the object from the ToF sensor 11 and the stereo RGB sensor 12.

FIG. 3 is an explanatory diagram for the case where the function adjuster 30 adjusts a sensing resolution function. In FIG. 3, the left photo is before adjusting the sensing resolution function, and the right photo is after adjusting the sensing resolution function.

In the case of low confidence, the function adjuster 30 can adjust the sensing resolution function to increase the resolutions of the ToF sensor 11 and the stereo RGB sensor 12.

FIG. 4 is an explanatory diagram for the case where the function adjuster 30 adjusts an illumination function. In FIG. 4, the left photo is before adjusting the illumination function, and the right photo is after adjusting the illumination function.

In the case of low confidence, the function adjuster 30 can adjust the illumination function to increase the illuminations of the ToF sensor 11 and the stereo RGB sensor 12.

Returning to FIG. 1, the 3D spatial scanning system 1 may further include the object discriminator 50.

The object discriminator 50 determines whether an object is discriminated within the region of interest (ROI) of the sensor group 10.

In the case where the 3D spatial scanning system 1 further includes the object discriminator 50, the function adjuster 30 adjusts the function again based on the discrimination result in the object discriminator 50.

For example, if no object is discriminated within the ROI, the function adjuster 30 can adjust the sensing distance so that an object enters the ROI. Alternatively or additionally, the function adjuster 30 can increase the sensing resolution and/or the illumination or reduce the light reflection.

Hereinafter, a 3D spatial scanning method according to the present disclosure will be described. In the following description of the 3D spatial scanning method, detailed description of the matters previously described in the 3D spatial scanning system 1 may be omitted.

The 3D spatial scanning method according to an embodiment of the present disclosure may include a sensing step S10, a confidence estimation step S20, a function adjustment step S30, and a fusion step S40.

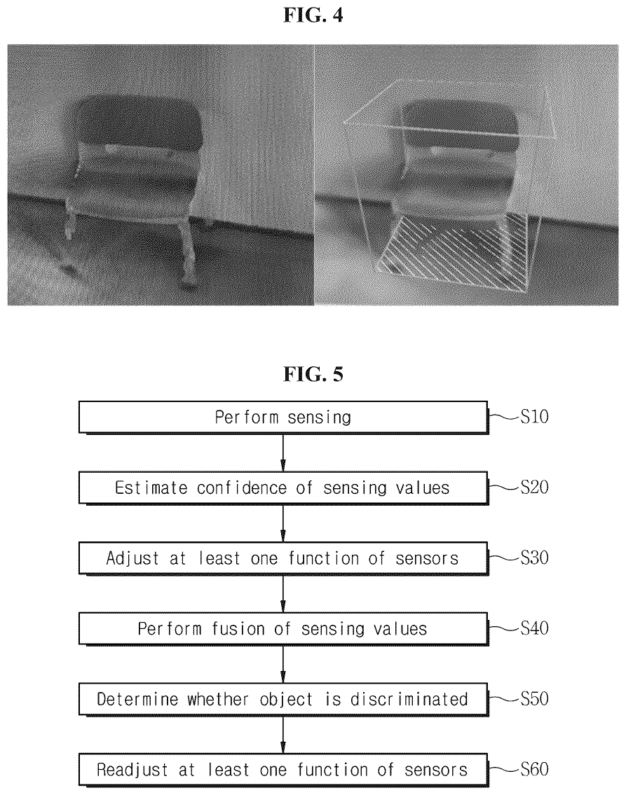

FIG. 5 is a flowchart showing a 3D spatial scanning method according to an embodiment of the present disclosure.

In the sensing step S10, space is scanned using the ToF sensor 11 and the stereo RGB sensor 12.

In the confidence estimation step S20, the sensing value of the ToF sensor 11 and the sensing value of the stereo RGB sensor 12 are fused and the confidence of such sensing values is estimated.

In the function adjustment step S30, the function of at least one of the ToF sensor 11 and the stereo RGB sensor 12 is adjusted based on the confidence estimated in the confidence estimation step S20. The sensor function adjusted in the function adjustment step S30 may include at least one of a sensing distance, a sensing resolution, a light reflection, and an illumination.

In the fusion step S40, the sensing value of the ToF sensor 11 and the sensing value of the stereo RGB sensor 12 are fused based on the function adjustment in the function adjustment step S30.

In some embodiments, the 3D spatial scanning method may further include an object discrimination step S50 and a function readjustment step S60.

In the object discrimination step S50, it is determined whether an object is discriminated within the region of interest (ROI) in the sensing step S10.

In the function readjustment step S60, the function of at least one of the ToF sensor 11 and the stereo RGB sensor 12 is readjusted based on the discrimination result in the object discrimination step S50.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A three-dimensional (3D) spatial scanning system comprising:
a sensor group configured to scan space using a time-of-flight (ToF) sensor and a stereo red-green-blue (RGB) sensor included therein;
a confidence estimator configured to fuse a sensing value of the ToF sensor and a sensing value of the stereo RGB sensor and estimate a confidence of the sensing values;
a function adjuster configured to adjust a function of at least one of the ToF sensor and the stereo RGB sensor based on the confidence estimated by the confidence estimator; and
a fusion processor configured to fuse the sensing value of the ToF sensor and the sensing value of the stereo RGB sensor based on function adjustment of the function adjuster.

2. The 3D spatial scanning system of claim 1, wherein the function adjusted by the function adjuster includes at least one of a sensing distance, a sensing resolution, a light reflection, and an illumination.

3. The 3D spatial scanning system of claim 1, further comprising:
an object discriminator configured to determine whether an object is discriminated within a region of interest (ROI) of the sensor group,
wherein the function adjuster is configured to adjust the function again based on a discrimination result in the object discriminator.

4. A three-dimensional (3D) spatial scanning method comprising:
scanning space using a time-of-flight (ToF) sensor and a stereo red-green-blue (RGB) sensor;
fusing a sensing value of the ToF sensor and a sensing value of the stereo RGB sensor and estimating a confidence of the sensing values;
adjusting a function of at least one of the ToF sensor and the stereo RGB sensor based on the estimated confidence; and
fusing the sensing value of the ToF sensor and the sensing value of the stereo RGB sensor based on the adjusted function in the function adjustment.

5. The 3D spatial scanning method of claim 4, further comprising:
determining whether an object is discriminated within a region of interest (ROI); and
readjusting the function of at least one of the ToF sensor or the stereo RGB sensor based on a discrimination result in the object discrimination.
